(19) United States
(12) Patent Application Publication
(10) Pub. No.: US 2026/0299453 A1
(43) Pub. Date: Oct. 1, 2026

(54) IMAGE FORMING APPARATUS

(71) Applicant: FUJIFILM Business Innovation Corp., Tokyo (JP)

(72) Inventors: Masahiko KUBO, Kanagawa (JP); Tomoshi HARA, Kanagawa (JP); Yasutomo ISHII, Kanagawa (JP); Yukiaki NAKAMURA, Kanagawa (JP)

(73) Assignee: FUJIFILM Business Innovation Corp., Tokyo (JP)

(21) Appl. No.: 19/313,109

(22) Filed: Aug. 28, 2025

(30) Foreign Application Priority Data
Mar. 26, 2025 (JP) 2025-052654

(51) Int. Cl. G03G 15/01; G03G 15/00

(52) U.S. Cl. CPC G03G 15/0189; G03G 15/0131; G03G 15/5016; G03G 15/6585; G03G 2215/0109

(57) ABSTRACT

An image forming apparatus includes a mover that moves a transfer medium; a basic-color image forming section that is an image forming section that forms an image by using toner of one or more colors selected from four colors including yellow, magenta, cyan, and black, the image being transferred to the transfer medium; and plural additional-color image forming sections, each of which forms an image by using toner of an additional color other than the four colors, the image being transferred to the transfer medium, in which the plural additional-color image forming sections include an upstream additional-color image forming section and a downstream additional-color image forming section located downstream of the upstream additional-color image forming section in a movement direction in which the transfer medium is moved, and in which the toner of the additional color used in the downstream additional-color image forming section has a charge amount greater than a charge amount of the toner of the additional color used in the upstream additional-color image forming section.

### CROSS-REFERENCE TO RELATED APPLICATIONS

This application is based on and claims priority under 35 USC 119 from Japanese Patent Application No. 2025-052654 filed Mar. 26, 2025.

### BACKGROUND

### (i) Technical Field

The present disclosure relates to an image forming apparatus.

### (ii) Related Art

U.S. Pat. No. 4,812,899 describes a reproduction for producing a multi-color printing on printing stock, wherein the multi-color printing is composed of plural elemental areas to which ink is applied and including the steps of dividing a picture surface into sub-surfaces of identical size, dividing every sub-surface into juxtaposed elemental areas so that each sub-surface has a chromatic component and an achromatic component.
U.S. Pat. No. 5,734,800 describes a printing system including a print grid including a combination of the color black and five basic ink colors, three to five of which having a predetermined portion of fluorescence.

### SUMMARY

An image with a wider color gamut may be formed by additionally using toner of a color other than four colors: yellow, magenta, cyan, and black.
Here, assume that the charge amount of the additional toner is small. In this case, there is a possibility that the small charge amount of the additional toner will cause a degradation of the quality of the image that is formed.
Aspects of non-limiting embodiments of the present disclosure relate to reducing the degradation of the image quality caused by toner having a small charge amount compared to when a location at which the toner is used to form an image is set without taking the charge amount of the toner into account.
Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including a mover that moves a transfer medium; a basic-color image forming section that is an image forming section that forms an image by using toner of one or more colors selected from four colors including yellow, magenta, cyan, and black, the image being transferred to the transfer medium; and plural additional-color image forming sections, each of which forms an image by using toner of an additional color other than the four colors, the image being transferred to the transfer medium, wherein the plural additional-color image forming sections include an upstream additional-color image forming section and a downstream additional-color image forming section located downstream of the upstream additional-color image forming section in a movement direction in which the transfer medium is moved, and wherein the toner of the additional color used in the downstream additional-color image forming section has a charge amount greater than a charge amount of the toner of the additional color used in the upstream additional-color image forming section.

### BRIEF DESCRIPTION OF THE DRAWINGS

Exemplary embodiments of the present disclosure will be described in detail based on the following figures, wherein:

FIG. 1 illustrates an image forming apparatus;

FIG. 2 illustrates an example of the hardware configuration of a controller;

FIGS. 3A and 3B illustrate the expansion of a color gamut according to an exemplary embodiment;

FIG. 4 illustrates colors obtained by combining fluorescent pink with non-fluorescent yellow and combining fluorescent pink with non-fluorescent cyan;

FIG. 5 illustrates another example of an image forming apparatus;

FIG. 6 illustrates a direct-transfer image forming apparatus; and

FIG. 7 illustrates another example of a direct-transfer image forming apparatus.

### DETAILED DESCRIPTION

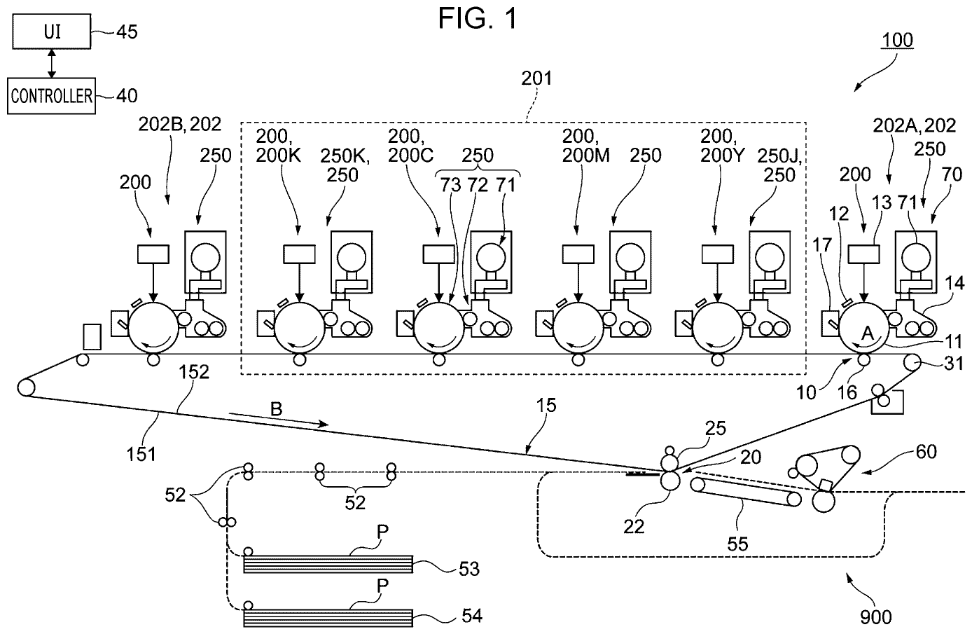

Exemplary embodiments of the present disclosure will be described with reference to the accompanying drawings.
FIG. 1 illustrates an image forming apparatus 100 according to an exemplary embodiment.
The image forming apparatus 100 is an intermediate-transfer image forming apparatus 100 referred to as a tandem image forming apparatus. The image forming apparatus 100 forms an image on a paper sheet P, which is an example of a recording medium.
The image forming apparatus 100 includes six image forming sections 200 that form toner images to be transferred to the paper sheet P. The image forming apparatus 100 also includes an intermediate transfer belt 15 as an example of a transfer medium. First, the toner images formed by the image forming sections 200 are transferred to the intermediate transfer belt 15.

The toner images formed by the image forming sections 200 are transferred to the intermediate transfer belt 15 by first transfer units 10.
The intermediate transfer belt 15 serves as the transfer medium to which the toner images formed by the image forming sections 200 are transferred.
In direct-transfer systems described below, the toner images formed by the image forming sections 200 are directly transferred to the paper sheet P, which is a recording medium. In this case, the paper sheet P serves as the transfer medium.

In the present exemplary embodiment, first, the toner images formed by the image forming sections 200 are transferred to the intermediate transfer belt 15. After that, the toner images are transferred to the paper sheet P.
The intermediate transfer belt 15 is a member that circulates. In other words, the intermediate transfer belt 15 is a member that rotates. The intermediate transfer belt 15 has an outer peripheral surface 151 that comes into the paper sheet P in a second transfer unit 20.

The toner images formed by the six image forming sections 200 are transferred to the outer peripheral surface 151 of the intermediate transfer belt 15. As the intermediate transfer belt 15 moves, the toner images that have been transferred to the outer peripheral surface 151 of the intermediate transfer belt 15 move to the second transfer unit 20. The toner images are transferred to the paper sheet P by the second transfer unit 20. Thus, an image composed of the toner images is placed on the paper sheet P.
In the second transfer unit 20, the outer peripheral surface 151 of the intermediate transfer belt 15 and the paper sheet P are in contact with each other. The second transfer unit 20 is a section in which the toner images transferred to the intermediate transfer belt 15 are transferred to the paper sheet P.

The image forming apparatus 100 also includes a fixing device 60 that fixes the toner images transferred to the paper sheet P to the paper sheet P.
The image forming apparatus 100 also includes a controller 40 that controls components of the image forming apparatus 100.
The image forming apparatus 100 also includes a user interface (UI) 45 that receives instructions from a user and presents information to the user. The UI 45 is, for example, a touch panel. The UI 45 is a receiver that receives instructions from the user and a display that displays information.
The receiver that receives instructions from the user and the display that displays information may be provided separately.

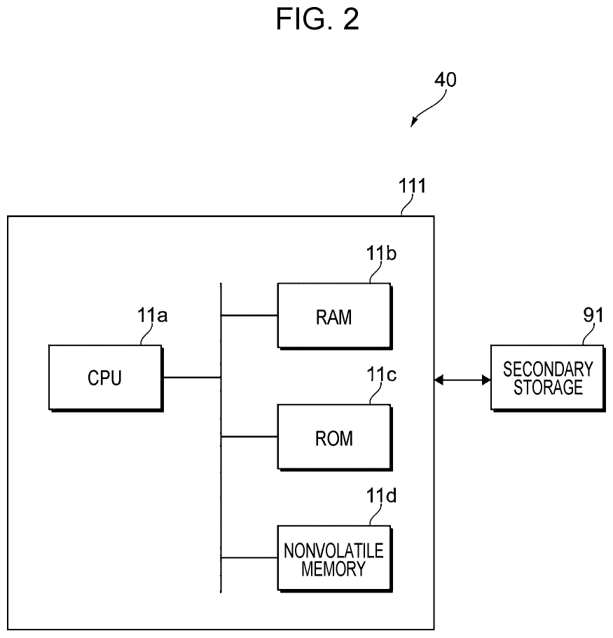

FIG. 2 illustrates the hardware configuration of the controller 40. A computer serves as the controller 40.
The controller 40 includes an arithmetic processing unit 111 that executes digital arithmetic processes in accordance with programs and a secondary storage 91 that stores information.
An existing information storage device, such as a hard disk drive (HDD), a semiconductor memory, or a magnetic tape, serves as the secondary storage 91.

The arithmetic processing unit 111 includes a CPU 11a as an example of a processor.
The arithmetic processing unit 111 also includes a RAM 11b used as, for example, a working memory for the CPU 11a. The arithmetic processing unit 111 also includes a ROM 11c that stores, for example, programs to be executed by the CPU 11a.
The arithmetic processing unit 111 also includes a nonvolatile memory 11d capable of retaining data even when the supply of power is stopped.

The nonvolatile memory 11d includes, for example, a battery-backed SRAM or a flash memory. The secondary storage 91 stores various types of information including the programs to be executed by the arithmetic processing unit 111.
In the present exemplary embodiment, the CPU 11a of the arithmetic processing unit 111 reads the programs stored in the ROM 11c or the secondary storage 91. The CPU 11a executes the programs stored in the ROM 11c or the secondary storage 91. Thus, various processes are performed in the image forming apparatus 100. The various processes performed in the image forming apparatus 100 are executed by the CPU 11a.

The programs to be executed by the CPU 11a may be provided to the image forming apparatus 100 by a storage medium.
The storage medium may be, for example, a magnetic storage medium, such as a magnetic tape or a magnetic disk. The storage medium may also be, for example, an optical storage medium, such as an optical disc.
The storage medium may also be, for example, a magneto-optical storage medium. The storage medium may also be, for example, a semiconductor memory.
The programs to be executed by the CPU 11a may be provided to the image forming apparatus 100 via a communication system, such as the Internet.

The image forming apparatus 100 will be further described with reference to FIG. 1.
Each image forming section 200 includes a developing device 14. Each image forming section 200 also includes a developer-supplying device 70 that supplies developer to the developing device 14.
The developing device 14 converts an electrostatic latent image on a photoconductor drum 11 into a visual image using toner.
The developer-supplying device 70 includes a toner cartridge 71. The developer-supplying device 70 transports developer from the toner cartridge 71 to the developing device 14, thereby supplying the developer to the developing device 14.
The developer includes carrier and toner. The developer-supplying device 70 supplies the carrier and the toner to the developing device 14. In the present exemplary embodiment, the carrier is dry carrier, and the toner is in the form of powder.

In each image forming section 200, the photoconductor drum 11, which is an example of an image carrier, rotates in the direction of arrow A.
Each image forming section 200 includes a charging device 12 that charges the photoconductor drum 11 and an exposure device 13 that forms an electrostatic latent image on the photoconductor drum 11.
The exposure device 13 includes a light source, such as an LED, and irradiates the photoconductor drum 11 with light. Thus, the electrostatic latent image is formed on a surface of the photoconductor drum 11 charged by the charging device 12.
After that, the developing device 14 supplies the toner to the surface of the photoconductor drum 11. Thus, the electrostatic latent image on the photoconductor drum 11 is converted into a visible image by using the toner. Thus, a toner image is formed on the surface of the photoconductor drum 11.

In the present exemplary embodiment, the developer is used to form the toner image, which is an image to be transferred to the paper sheet P, on the photoconductor drum 11, which is an example of an image carrier.
In each image forming section 200, the developer in the form of powder is used to form the toner image to be transferred to the paper sheet P on the photoconductor drum 11. Thus, the photoconductor drum 11 temporarily holds the toner image.
Then, in the present exemplary embodiment, the toner image temporarily held by the photoconductor drum 11 is transferred to the outer peripheral surface 151 of the intermediate transfer belt 15 by the corresponding first transfer unit 10, which includes a first transfer roller 16.
In the present exemplary embodiment, after the toner image is transferred to the intermediate transfer belt 15, a drum cleaner 17 removes the toner remaining on the photoconductor drum 11.

The intermediate transfer belt 15 is circulated in the direction of arrow B in FIG. 1 by a driving roller 31 driven by a motor (not illustrated). This motor and the driving roller 31 serve as a mover that moves the intermediate transfer belt 15.
The toner image formed on each photoconductor drum 11 is electrostatically attracted and transferred to the intermediate transfer belt 15 in the corresponding first transfer unit 10. Thus, the toner images of respective colors are superposed on the intermediate transfer belt 15.

The second transfer unit 20 includes a second transfer roller 22 provided on the outer peripheral surface 151 of the intermediate transfer belt 15 and a backup roller 25 provided on an inner peripheral surface 152 of the intermediate transfer belt 15.
In the present exemplary embodiment, the second transfer unit 20 transfers the toner images transferred to the intermediate transfer belt 15 to the paper sheet P transported to the second transfer unit 20.

The toner images formed by the image forming sections 200 are transferred to the intermediate transfer belt 15, and then moved to the second transfer unit 20 by the movement of the intermediate transfer belt 15.
At this time, the paper sheet P fed from a first sheet storage unit 53 or a second sheet storage unit 54 is transported to the second transfer unit 20 by transport rollers 52.
The toner images on the intermediate transfer belt 15 are collectively electrostatically transferred to the paper sheet P by the second transfer unit 20.

After that, the paper sheet P to which the toner images have been transferred is separated from the intermediate transfer belt 15 and transported to the transport belt 55. The transport belt 55 transports the paper sheet P to the fixing device 60.
The paper sheet P transported to the fixing device 60 is heated and pressed by the fixing device 60. Thus, the toner images on the paper sheet P are fixed to the paper sheet P. Then, the paper sheet P is output from the image forming apparatus 100.

In the present exemplary embodiment, a reversing mechanism 900 for reversing the paper sheet P is additionally provided.
The reversing mechanism 900 reverses the paper sheet P after the toner images are transferred to one side of the paper sheet P by the second transfer unit 20, and then supplies the paper sheet P to the second transfer unit 20 again. Thus, in the present exemplary embodiment, the toner images are formed on both sides of the paper sheet P.

### Description of Image Forming Sections

The image forming sections 200 will be further described.
In the present exemplary embodiment, six image forming sections 200 are provided.
The six image forming sections 200 form toner images using different types of toner. The six image forming sections 200 form toner images to be transferred to the intermediate transfer belt 15 using toner, which is an example of a coloring material.
In the present exemplary embodiment, four of the six image forming sections 200 that are indicated by reference sign 201 form toner images using toners of basic colors, which are yellow, magenta, cyan, and black. In the present exemplary embodiment, the toners of basic colors refer to the toners of four colors, which are yellow, magenta, cyan, and black.

In the present exemplary embodiment, the four image forming sections 200 indicated by reference sign 201 include a yellow image forming section 200Y that forms a toner image using non-fluorescent yellow toner.
The four image forming sections 200 also include a magenta image forming section 200M that forms a toner image using non-fluorescent magenta toner and a cyan image forming section 200C that forms a toner image using non-fluorescent cyan toner.
The four image forming sections 200 also include a black image forming section 200K that forms a toner image using non-fluorescent black toner.

Each of the yellow image forming section 200Y, the magenta image forming section 200M, the cyan image forming section 200C, and the black image forming section 200K forms a toner image to achieve color reproduction in accordance with ISO12647-2, which is an international standard regarding offset printing.
Examples of the color reproduction in accordance with ISO12647-2 include JapanColor Fogra, and SWOP.
When a toner image is formed to achieve the color reproduction in accordance with

ISO12647-2, color reproduction equivalent to that of normal offset printing may be achieved, and a printed material with high lightfastness may be obtained.

In this specification, the above-described four image forming sections 200 indicated by reference sign 201 may be referred to as “basic-color image forming sections 201”.
The basic-color image forming sections 201, which are examples of non-fluorescent image forming sections, form toner images to be transferred to the intermediate transfer belt 15 using one or more of the toners of four basic colors, which are yellow, magenta, cyan, and black.

The image forming sections 200 to be used among the basic-color image forming sections 201 change depending on the image to be formed on the paper sheet P. The basic-color image forming sections 201 form toner images using one or more of the toners of four colors.

When, for example, a monochrome image is to be formed on the paper sheet P, the basic-color image forming sections 201 form a toner image using the black toner.
When a full-color image is to be formed on the paper sheet P, the basic-color image forming sections 201 form toner images using the toners of four colors.

In the present exemplary embodiment, the remaining two image forming sections 200 of the six image forming sections 200 serve as additional-color image forming sections 202.
The additional-color image forming sections 202 form images using fluorescent toner. The additional-color image forming sections 202 are capable of forming toner images using fluorescent toner.
Plural additional-color image forming sections 202 are provided.
In the present exemplary embodiment, the additional-color image forming sections 202 include an upstream additional-color image forming section 202A and a downstream additional-color image forming section 202B.

In a movement direction in which the intermediate transfer belt 15 moves, the upstream additional-color image forming section 202A is located upstream of the downstream additional-color image forming section 202B.
In the movement direction of the intermediate transfer belt 15, the upstream additional-color image forming section 202A is located upstream of the basic-color image forming sections 201.
In the movement direction of the intermediate transfer belt 15, the downstream additional-color image forming section 202B is located downstream of the basic-color image forming sections 201.

Each of the upstream additional-color image forming section 202A and the downstream additional-color image forming section 202B forms a toner image using fluorescent toner.
Of the upstream additional-color image forming section 202A and the downstream additional-color image forming section 202B, one additional-color image forming section 202 forms a toner image using fluorescent toner of one color. The other additional-color image forming section 202 forms a toner image using fluorescent toner of another color that differs from the one color.
Each of the upstream additional-color image forming section 202A and the downstream additional-color image forming section 202B forms a toner image using fluorescent toner of a color other than yellow, magenta, cyan, or black.

More specifically, the upstream additional-color image forming section 202A forms a pink toner image using fluorescent pink toner. The downstream additional-color image forming section 202B forms a green toner image using fluorescent green toner.
The upstream additional-color image forming section 202A is capable of forming a toner image using the fluorescent pink toner. The downstream additional-color image forming section 202B is capable of forming a toner image using the fluorescent green toner.
In the present exemplary embodiment, since the upstream additional-color image forming section 202A and the downstream additional-color image forming section 202B are provided, an image with a wider color gamut may be formed on the paper sheet P compared to the case in which only the basic-color image forming sections 201 is provided.

There is no particular limitation regarding the fluorescent green toner as long as the toner is fluorescent. In the present exemplary embodiment, the fluorescent green toner has a hue angle of 125 degrees or more and 165 degrees or less.
There is no particular limitation regarding the fluorescent pink toner as long as the toner is fluorescent. In the present exemplary embodiment, the fluorescent pink toner has a hue angle of −25 degrees or more and 15 degrees or less.
The fluorescent toner includes toner particles containing a fluorescent colorant and a binder resin and also containing a release agent and other additives as necessary.

Here, the fluorescent colorant refers to a colorant that emits light in response to external light energy. This colorant may be a dye or a pigment. The fluorescent toner according to the present exemplary embodiment emits light in response to external light energy.
The fluorescent toner according to the present exemplary embodiment develops color through reflected light and emitted light.
In contrast, non-fluorescent toner contains no fluorescent colorant and does not emit light in response to external light energy. The non-fluorescent toner develops color only through reflected light.

The upstream additional-color image forming section 202A may be regarded as an upstream fluorescent image forming section that uses fluorescent toner of an additional color, which is a color other than the above-described basic colors, to form a toner image to be transferred to the intermediate transfer belt 15.
The downstream additional-color image forming section 202B may be regarded as a downstream fluorescent image forming section that uses fluorescent toner of an additional color, which is a color other than the above-described basic colors, to form a toner image to be transferred to the intermediate transfer belt 15.
The upstream additional-color image forming section 202A forms a fluorescent toner image, and therefore may also be referred to as an upstream fluorescent image forming section. The downstream additional-color image forming section 202B also forms a fluorescent toner image, and therefore may also be referred to as a downstream fluorescent image forming section.

The above-described configuration does not imply any limitation, and the upstream additional-color image forming section 202A may form a toner image using fluorescent green toner. In addition, the downstream additional-color image forming section 202B may form a toner image using fluorescent pink toner.
Each of the upstream additional-color image forming section 202A and the downstream additional-color image forming section 202B may form a toner image using fluorescent toner of other colors, such as fluorescent yellow toner or fluorescent orange toner. When a fluorescent coloring material is used, the color gamut expands in light and highly saturated color regions.

The additional-color image forming sections 202 are capable of forming toner images using at least one type of fluorescent toner selected from fluorescent pink toner, fluorescent green toner, fluorescent yellow toner, and fluorescent orange toner.
In the present exemplary embodiment, the additional-color image forming sections 202 are capable of forming toner images using fluorescent toner.
In contrast, no fluorescent toner is used in the yellow image forming section 200Y, the magenta image forming section 200M, the cyan image forming section 200C, and the black image forming section 200K.
The yellow image forming section 200Y, the magenta image forming section 200M, the cyan image forming section 200C, and the black image forming section 200K form toner images using non-fluorescent toner.

In the present exemplary embodiment, an image may be formed in four image forming modes, which are first to fourth image forming modes described below.
A first image forming mode is a mode in which toner images are formed by operating the basic-color image forming sections 201 without operating the upstream additional-color image forming section 202A or the downstream additional-color image forming section 202B.
A second image forming mode is a mode in which toner images are formed by operating the basic-color image forming sections 201 and the downstream additional-color image forming section 202B without operating the upstream additional-color image forming section 202A.
A third image forming mode is a mode in which toner images are formed by operating the basic-color image forming sections 201 and the upstream additional-color image forming section 202A without operating the downstream additional-color image forming section 202B.
A fourth image forming mode is a mode in which toner images are formed by operating the upstream additional-color image forming section 202A, the downstream additional-color image forming section 202B, and the basic-color image forming sections 201.
Here, the expression “operating the basic-color image forming sections 201” covers a case in which only some of the above-described image forming sections 200 for the four colors indicated by reference sign 201 are operated, for example, only one of the image forming sections 200 is operated.

In the present exemplary embodiment, the user selects their desired image forming mode from the above-described four image forming modes through the UI 45.
The CPU 11a selects the image forming sections 200 to be operated based on the image forming mode selected by the user, and operates the selected image forming sections 200.
In this case, components of the image forming apparatus 100 are operated in one of the above-described four image forming modes that is selected by the user.
In the present exemplary embodiment, an image may be formed on the paper sheet P without using the upstream additional-color image forming section 202A or the downstream additional-color image forming section 202B.
The image formed on the paper sheet P without using the upstream additional-color image forming section 202A or the downstream additional-color image forming section 202B contains no fluorescent toner.

When widely used CMYK coloring materials are used, only colors in a small color gamut may be reproduced. In this case, light colors and saturated colors reproducible in RGB cannot be easily reproduced. In other words, light colors and saturated colors reproducible by a monitor or the like cannot be easily reproduced.
Additionally, when CMYK coloring materials are used, colors of special-color ink cannot be reproduced.

In relation to these problems, high-fidelity (Hi-Fi) color printing (U.S. Pat. No. 4,812,899) is known which uses seven coloring materials including non-fluorescent OGV coloring materials, which correspond to RGB, in addition to the CMYK coloring materials. The OGV coloring materials are orange, green, and violet coloring materials.
Hi-Fi color printing enables the expansion of a color gamut in RGB directions. In this case, reproduction of special colors may be improved.
However, in Hi-Fi color printing, it is difficult to reproduce light colors and saturated colors, and it is also difficult to reproduce RGB. In addition, since an image forming apparatus that performs Hi-Fi color printing includes seven color units, the apparatus tends to be large and costly.

Additionally, hexachrome printing (U.S. Pat. No. 5,734,800) is known.
Hexachrome printing uses a fluorescent yellow coloring material, a fluorescent orange coloring material, a fluorescent magenta coloring material, a non-fluorescent cyan coloring material, a non-fluorescent black coloring material, and a non-fluorescent green coloring material.
In hexachrome printing, six coloring materials are used. In this case, the apparatus includes six color units, and is smaller than the image forming apparatus that performs Hi-Fi color printing.

In hexachrome printing, since fluorescent coloring materials are used for colors in the red direction, RGB is reproducible in the red direction.
However, with regard to other directions, no fluorescent coloring materials are used, and the color gamut is small. In hexachrome printing, it is still difficult to reproduce RGB and colors of special-color ink.

In addition, in hexachrome printing, a heavy workload is placed on the operator.
In hexachrome printing, when an image with high lightfastness is to be formed by using only the coloring materials of the basic CMYK colors, the fluorescent yellow coloring material and the fluorescent magenta coloring material need to be replaced with a non-fluorescent yellow coloring material and a non-fluorescent magenta coloring material.
In this case, a heavy workload is placed on the operator.
An image including fluorescent coloring materials tends to have low lightfastness. To form an image with high lightfastness, the fluorescent yellow coloring material and the fluorescent magenta coloring material need to be replaced with a non-fluorescent yellow coloring material and a non-fluorescent magenta coloring material. In this case, a heavy workload is placed on the operator.

In contrast, in the image forming apparatus 100 according to the present exemplary embodiment, non-fluorescent toner is used for the four CMYK colors.
In this case, the image forming apparatus 100 of the present exemplary embodiment is capable of forming an image with high lightfastness using only the coloring materials of the basic CMYK colors simply by making a setting such that the fluorescent pink toner and the fluorescent green toner are not to be used.
The image forming apparatus 100 of the present exemplary embodiment is capable of forming an image with high lightfastness without replacing the fluorescent yellow coloring material and the fluorescent magenta coloring material with a non-fluorescent yellow coloring material and a non-fluorescent magenta coloring material. In this case, an image with high lightfastness may be formed without placing a heavy workload on the operator.

In addition, according to the present exemplary embodiment, the fluorescent pink toner and the fluorescent green toner may be used to reproduce, in printing, RGB and colors of special-color ink that have been difficult to reproduce by the above-described methods of the related art. In addition, in the present exemplary embodiment, these colors may be reproduced by using six color units.

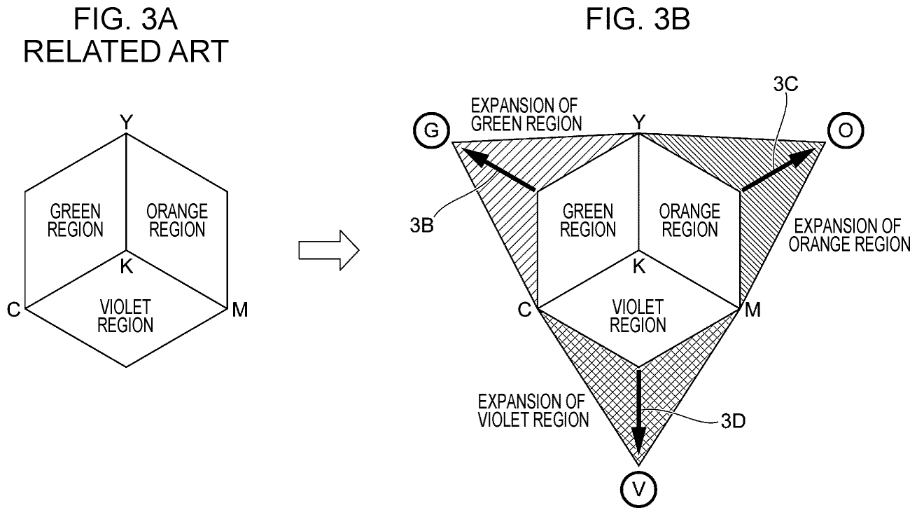

FIGS. 3A and 3B illustrate the expansion of a color gamut according to the present exemplary embodiment.
FIG. 3A illustrates a color gamut according to the related art. The color gamut illustrated in FIG. 3A is smaller than the color gamut illustrated in FIG. 3B.
According to the present exemplary embodiment, as shown by arrow 3B in FIG. 3B, the color gamut is expanded in a green region due to fluorescent green. Thus, RGB is reproducible in the green direction.

In addition, according to the present exemplary embodiment, as shown by arrows 3C and 3D in FIG. 3B, the color gamut is expanded in the orange region and the violet region due to the fluorescent pink toner.
Thus, according to the present exemplary embodiment, RGB is also reproducible in the orange direction and the violet direction.

In the present exemplary embodiment, the color gamut is expanded in the orange region, as shown by arrow 3C, by the combination of the non-fluorescent yellow toner indicated by “Y” in FIG. 3B and the fluorescent pink toner.
In addition, in the present exemplary embodiment, the color gamut is expanded in the violet region, as shown by arrow 3D, by the combination of the non-fluorescent cyan toner indicated by “C” in FIG. 3B and the fluorescent pink toner.
Thus, RGB is also reproducible in the orange direction and the violet direction.

As a result, in the present exemplary embodiment, RGB is reproducible in all three RGB directions. In addition, in the present exemplary embodiment, the color reproduction in all three RGB directions is achieved using two colors, which are fluorescent green and fluorescent pink, instead of three colors.
In the present exemplary embodiment, six colors including the four basic colors, fluorescent green, and fluorescent pink are used, and the color gamut may be expanded in the three RGB directions by using six color units.
In addition, fluorescent toner is used to expand the color gamut in each of the three RGB directions. In this case, light colors and saturated colors with high color forming performance that are reproducible by a monitor or the like may be reproduced.
In addition, according to the present exemplary embodiment, as described above, when an image with high lightfastness is to be formed, the image with high lightfastness may be formed without placing a heavy workload on the operator.

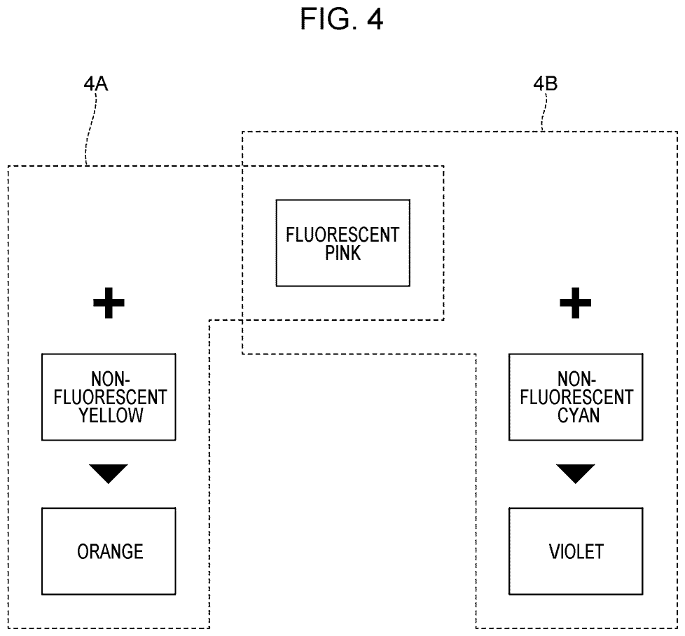

FIG. 4 illustrates colors obtained by combining fluorescent pink with non-fluorescent yellow and combining fluorescent pink with non-fluorescent cyan.
In the present exemplary embodiment, as indicated by reference sign 4A, orange color is obtained by combining fluorescent pink and non-fluorescent yellow.
In addition, in the present exemplary embodiment, as indicated by reference sign 4B, violet color is obtained by combining fluorescent pink and non-fluorescent cyan.
In addition, in the present exemplary embodiment, as described above, fluorescent green is also prepared.
In this case, according to the present exemplary embodiment, fluorescent coloring materials corresponding to the three RGB colors are substantially provided. In this case, the color gamut may be expanded in the three RGB directions with high color forming performance.

### Replacement of Units

The following description refers to FIG. 1 again.
In the present exemplary embodiment, each of the six image forming sections 200 includes an image forming unit 250 that is removable therefrom. Each image forming section 200 enables the corresponding image forming unit 250 to be removed therefrom and another image forming unit 250 that differs from the removed image forming unit 250 to be attached thereto.
In the present exemplary embodiment, as illustrated in FIG. 1, the six image forming sections 200 include the respective image forming units 250 that are used to form an image.
The image forming units 250 are arranged in the movement direction of the intermediate transfer belt 15.
In the present exemplary embodiment, each image forming unit 250 may be replaced with another image forming unit 250 to enable the corresponding image forming section 200 after the replacement to form a toner image different from a toner image formed before the replacement.

In the present exemplary embodiment, each image forming unit 250 includes plural members including a toner cartridge 71, a developing unit 72, and a drum unit 73.
In the present exemplary embodiment, when the image forming unit 250 is replaced, some or all of the members included in the image forming unit 250 are replaced. When the image forming unit 250 is replaced, at least the toner cartridge 71 is replaced.
The replacement of the image forming unit 250 is not limited to the replacement of all members of the image forming unit 250, but includes the case in which some of the members are replaced.
When the image forming unit 250 is replaced, the toner image formed by the image forming section 200 is changed to another toner image.

In the present exemplary embodiment, the replacement of the image forming unit 250 enables, for example, a toner image to be formed by using toner containing metal powder, white toner, toner with adhesive performance, or transparent toner.
The toner with adhesive performance is toner capable of forming a toner image to which adhesiveness may be imparted by applying pressure or heat.
In this specification, the toner containing metal powder, white toner, toner with adhesive performance, transparent toner, or the like may be referred to as “functional toner”.

To use the functional toner, for example, the image forming unit 250 of the upstream additional-color image forming section 202A or the downstream additional-color image forming section 202B is replaced.
In the present exemplary embodiment, the replacement of the image forming unit 250 enables a toner image having a function different from the function of a toner image formed before the replacement of the image forming unit 250 to be formed.

The toner containing metal powder, white toner, toner with adhesive performance, and transparent toner are non-fluorescent toner.
In the present exemplary embodiment, each of the upstream additional-color image forming section 202A and the downstream additional-color image forming section 202B is capable of forming a toner image using non-fluorescent toner.
Assume that the image forming unit 250 is replaced in each of the upstream additional-color image forming section 202A and the downstream additional-color image forming section 202B to enable the use of the functional toner. In this case, each of the upstream additional-color image forming section 202A and the downstream additional-color image forming section 202B is capable of forming a toner image using non-fluorescent toner.

When the upstream additional-color image forming section 202A and the downstream additional-color image forming section 202B form toner images using the functional toner, toner images formed by using the functional toner are located on a surface-layer side and a paper-sheet-P side of the image formed on the paper sheet P.
In the present exemplary embodiment, the replacement of the image forming units 250 enables an image that is highly reflective of light and an image with adhesive performance to be formed on the paper sheet P.
In the present exemplary embodiment, the toner containing metal powder may be used to form an image that is highly reflective of light on the paper sheet P.
In addition, in the present exemplary embodiment, the toner with adhesive performance may be used to form an image with adhesive performance on the paper sheet P.

In addition, in the present exemplary embodiment, the replacement of the image forming units 250 enables toner images to be formed in colors different from the colors of toner images formed before the replacement.
In the present exemplary embodiment, the replacement of the image forming units 250 enables a toner image with metallic luster, a white toner image, and a transparent toner image to be formed as toner images included in the image formed on the paper sheet P.
The toner image formed by using the toner containing metal powder is a toner image with metallic luster. The toner image formed by using the white toner is a white toner image. The toner image formed by using the transparent toner is a transparent toner image.

The color of the toner image with metallic luster, the color of the white toner image, and the color of the transparent toner image differ from the color of the toner image formed by using the fluorescent pink toner.
The color of the toner image with metallic luster, the color of the white toner image, and the color of the transparent toner image differ from the color of the toner image formed by using the fluorescent green toner.
In the present exemplary embodiment, the replacement of the image forming units 250 enables toner images to be formed in colors different from the colors of toner images formed before the replacement of the image forming units 250.

In the present exemplary embodiment, the upstream additional-color image forming section 202A and the downstream additional-color image forming section 202B are provided.
Accordingly, layers of the functional toner may be formed on both the paper-sheet-P side and the surface-layer side of the layers of basic-color toner images formed by using the above-described toners of four colors.
In the present exemplary embodiment, an image is finally formed on the paper sheet P. This image includes a surface-layer-side section located on the surface-layer side and a paper-sheet-side section located on the paper-sheet-P side.
When the upstream additional-color image forming section 202A and the downstream additional-color image forming section 202B are provided, the layers of the functional toner may be formed in both the surface-layer-side section and the paper-sheet-side section.

Here, assume that the toner containing metal powder is used. In addition, assume that the downstream additional-color image forming section 202B is not provided, and only the upstream additional-color image forming section 202A is provided.
In this case, there is a possibility that the basic-color toner images will be covered by the layer of the toner image with metallic luster.
In this case, the layer of the toner image with metallic luster is located in the surface-layer-side section. In this case, the basic-color toner images are covered by the layer of the toner image with metallic luster.

In contrast, according to the present exemplary embodiment, the downstream additional-color image forming section 202B is provided.
In this case, the layer of the toner image with metallic luster may be formed in the paper-sheet-side section.
When the toner with metallic luster is used in the downstream additional-color image forming section 202B, the layer of the toner image with metallic luster is formed in the paper-sheet-side section.
In this case, the basic-color toner images may be prevented from being covered. In addition, in this case, a bright image may be formed on the paper sheet P.

In another case, assume that the white toner is used. In addition, assume that the downstream additional-color image forming section 202B is not provided, and only the upstream additional-color image forming section 202A is provided.
In this case, the layer of the white toner tends to be located in the surface-layer-side section. In this case, the layer of the white toner cannot easily function as an underlayer.
White toner is often used to form an underlayer. When only the upstream additional-color image forming section 202A is provided, the layer of the white toner cannot function as an underlayer.

In contrast, according to the present exemplary embodiment, the downstream additional-color image forming section 202B is provided. Accordingly, the layer of the white toner may be easily located in the paper-sheet-side section.
When the white toner is used in the downstream additional-color image forming section 202B, the layer of the white toner is located in the paper-sheet-side section.
In this case, the layer of the white toner may function as the underlayer.

In another case, assume that the toner with adhesive performance is used. In addition, assume that the upstream additional-color image forming section 202A is not provided, and only the downstream additional-color image forming section 202B is provided.
In this case, the layer of the toner with adhesive performance tends to be located in the paper-sheet-side section. In this case, the layer of the toner with adhesive performance cannot easily function as an adhesive layer.
The layer of the toner with adhesive performance function as an adhesive when, for example, the paper sheet P is folded and bonded together.

In this case, when the layer of the toner with adhesive performance tends to be located in the paper-sheet-side section, the layer of the toner with adhesive performance cannot easily function as an adhesive layer.
In contrast, in the present exemplary embodiment, the upstream additional-color image forming section 202A is provided. In this case, the layer of the toner with adhesive performance may be formed in the surface-layer-side section.
In this case, the toner with adhesive performance may be used in the upstream additional-color image forming section 202A, so that the layer of the toner with adhesive performance is formed in the surface-layer-side section.
In this case, the layer of the toner with adhesive performance may easily function as an adhesive layer.

In another case, assume that the transparent toner is used. In addition, assume that the upstream additional-color image forming section 202A is not provided, and only the downstream additional-color image forming section 202B is provided.
In this case, the layer of the transparent toner tends to be located not in the surface-layer-side section, but in the paper-sheet-side section. In this case, the layer of the transparent toner cannot easily function as a layer for increasing the transfer efficiency of the basic-color toner images.
In contrast, when the upstream additional-color image forming section 202A is provided as in the present exemplary embodiment, the layer of the transparent toner may be formed in the surface-layer-side section.

In this case, the layer of the transparent toner may easily function as a layer for increasing the transfer efficiency of the basic-color toner images.
When the layer of the transparent toner is provided in the surface-layer-side section, the basic-color toner images do not easily remain on the outer peripheral surface 151 of the intermediate transfer belt 15.
When the layer of the transparent toner is provided in the surface-layer-side section, the basic-color toner images do not easily remain on the outer peripheral surface 151 after the toner images are transferred from the outer peripheral surface 151 to the paper sheet P.
In this case, the efficiency of transfer of the basic-color toner images to the paper sheet P may be increased.

When the layer of the transparent toner is provided in the surface-layer-side section, the layer of the transparent toner is positioned between the outer peripheral surface 151 and the basic-color toner images after the toner images of respective colors are transferred to the outer peripheral surface 151.
In this case, the basic-color toner images do not easily come into direct contact with the outer peripheral surface 151.
In this case, when the toner images are transferred from the outer peripheral surface 151 to the paper sheet P, the basic-color toner images do not easily remain on the outer peripheral surface 151. In this case, the efficiency of transfer of the basic-color toner images to the paper sheet P is increased.
When the upstream additional-color image forming section 202A is not provided and only the downstream additional-color image forming section 202B is provided, the layer of the transparent toner cannot be easily formed in the surface-layer-side section. In this case, the transfer efficiency of the basic-color toner images cannot be easily increased.

In the present exemplary embodiment, as described above, the upstream additional-color image forming section 202A and the downstream additional-color image forming section 202B are both provided. The structure of the present exemplary embodiment is not such that only one of the upstream additional-color image forming section 202A and the downstream additional-color image forming section 202B is provided.
In this case, the occurrence of the above-described problems that arise when only one of the additional-color image forming sections is provided may be reduced.
In other words, the occurrence of the problems in which the basic-color toner images are covered and in which the layer of the white toner cannot easily function as an underlayer may be reduced. In addition, the occurrence of the problems in which the layer of the toner with adhesive performance cannot easily function as an adhesive layer and in which the transfer efficiency of the basic-color toner images cannot be easily increased may be reduced.

In this specification, among the image forming units 250 included in the basic-color image forming sections 201, the image forming unit 250 at the most downstream location in the movement direction of the intermediate transfer belt 15 will be referred to as a “most downstream image forming unit 250K”.
In the present exemplary embodiment, the image forming unit 250 included in the black image forming section 200K corresponds to the most downstream image forming unit 250K.

In addition, in this specification, among the image forming units 250 included in the basic-color image forming sections 201, the image forming unit 250 at the most upstream location in the movement direction of the intermediate transfer belt 15 will be referred to as a “most upstream image forming unit 250J”.
In the present exemplary embodiment, the image forming unit 250 included in the yellow image forming section 200Y corresponds to the most upstream image forming unit 250J.

In the present exemplary embodiment, since the downstream additional-color image forming section 202B is provided, a toner image may be formed by using toner of a color other than the basic colors at a location downstream of the basic-color image forming sections 201 without removing the most downstream image forming unit 250K.
More specifically, a toner image may be formed by using the above-described fluorescent toner or functional toner at a location downstream of the basic-color image forming sections 201.
In the present exemplary embodiment, a toner image may be formed by using toner of a color other than the basic colors without removing the most downstream image forming unit 250K, which is the image forming unit 250 corresponding to black.

Assume that the downstream additional-color image forming section 202B is not provided and only the basic-color image forming sections 201 and the upstream additional-color image forming section 202A are provided.
Also in this structure, a toner image may be formed by using toner of a color other than t basic colors at a location downstream of the basic-color image forming sections 201 by removing the most downstream image forming unit 250K.
More specifically, in this case, the most downstream image forming unit 250K that has been removed is attached to the upstream additional-color image forming section 202A. An image forming unit 250 used to form a toner image of a color other than the basic colors is installed into the space from which the most downstream image forming unit 250K has been removed.
Thus, a toner image may be formed by using toner of a color other than the basic colors at a location downstream of the basic-color image forming sections 201.

However, in this case, the most downstream image forming unit 250K needs to be relocated, and a heavy workload is placed on the operator. More specifically, the most downstream image forming unit 250K needs to be removed and then installed into the upstream additional-color image forming section 202A, and thus a heavy workload is placed on the operator.
In contrast, in the present exemplary embodiment, the downstream additional-color image forming section 202B is provided.
In this case, a toner image may be formed by using toner of a color other than the basic colors at a location downstream of the basic-color image forming sections 201 without removing the most downstream image forming unit 250K.

Similarly, in the present exemplary embodiment, since the upstream additional-color image forming section 202A is provided, a toner image may be formed by using toner of a color other than the basic colors at a location upstream of the basic-color image forming sections 201 without removing the most upstream image forming unit 250J.
In the present exemplary embodiment, a toner image may be formed by using toner of a color other than the basic colors at a location upstream of the basic-color image forming sections 201 without removing the most upstream image forming unit 250J, which is the image forming unit 250 corresponding to yellow.

### Form in Which Image Forming Apparatus is Shipped

The image forming apparatus 100 that has been manufactured may be shipped in a form in which no image forming unit 250 is attached to the upstream additional-color image forming section 202A or the downstream additional-color image forming section 202B.
Also in this case, in the present exemplary embodiment, the location of the upstream additional-color image forming section 202A may be set to function as a fluorescent-toner image forming section, which is an image forming section 200 that forms an image using fluorescent toner of one color.

In the present exemplary embodiment, the image forming unit 250 that forms an image using fluorescent toner is attached to the upstream additional-color image forming section 202A afterwards, so that the location of the upstream additional-color image forming section 202A functions as a fluorescent-toner image forming section.
More specifically, for example, the location of the upstream additional-color image forming section 202A may be set to function as a fluorescent-toner image forming section that forms an image using fluorescent pink toner.
In the present exemplary embodiment, even when no image forming unit 250 is initially attached, the image forming unit 250 may be attached afterwards to enable the upstream additional-color image forming section 202A to form a fluorescent toner image.

Similarly, even when the image forming apparatus 100 is shipped in a form in which no image forming unit 250 is attached to the downstream additional-color image forming section 202B, the location of the downstream additional-color image forming section 202B may be set to function as a fluorescent-toner image forming section.
After the image forming apparatus 100 is shipped, a unit that forms an image using fluorescent toner may be attached to the downstream additional-color image forming section 202B so that the location of the downstream additional-color image forming section 202B functions as a fluorescent-toner image forming section that forms an image using fluorescent toner of another color.
More specifically, for example, the location of the downstream additional-color image forming section 202B may be set to function as a fluorescent-toner image forming section that forms an image using fluorescent green toner.

### Toner Particle Diameter

In the present exemplary embodiment, the average particle diameter of the fluorescent toner used in each of the upstream additional-color image forming section 202A and the downstream additional-color image forming section 202B is greater than the average particle diameter of the non-fluorescent toner used in the basic-color image forming sections 201.
In the present exemplary embodiment, the average particle diameter of the fluorescent toner used in each of the additional-color image forming sections 202 is greater than the average particle diameters of the non-fluorescent yellow, magenta, cyan, and black toners.

More specifically, the average particle diameters of the fluorescent pink toner and the fluorescent green toner are greater than the average particle diameters of the non-fluorescent yellow, magenta, cyan, and black toners.
In addition, in the present exemplary embodiment, the average particle diameters of the above-described fluorescent yellow toner and fluorescent orange toner are also greater than the average particle diameters of the non-fluorescent yellow, magenta, cyan, and black toners.

In the present exemplary embodiment, the average particle diameter of the non-fluorescent toner is 3 to 5 μm. More specifically, the average particle diameter is 3 to 5 μm for each of the above-described four basic colors.
In contrast, the average particle diameter of the fluorescent toner is 5 to 8 μm.
In this specification, each of the numerical ranges defined using “to” refers to a range that does not include the values before and after “to” as minimum and maximum values.
In the present exemplary embodiment, the average particle diameter of the fluorescent toner used in each of the additional-color image forming sections 202 is greater than the average particle diameter of the non-fluorescent toner used in each of the basic-color image forming sections 201.
Accordingly, in the present exemplary embodiment, an image with improved quality and a wider color gamut may be easily formed on the paper sheet P.

When fluorescent toner is used in addition to non-fluorescent toner as in the present exemplary embodiment, the color gamut of an image that is formed may be increased compared to when only the non-fluorescent toner is used.
In general, as the particle diameter of toner decreases, the granularity of the toner increases so that an image with higher quality may be formed. However, when the particle diameter of fluorescent toner is similarly reduced, the color forming performance is reduced and the color gamut cannot be easily expanded.
Accordingly, in the present exemplary embodiment, the average particle diameter of the fluorescent toner is greater than the average particle diameter of the non-fluorescent toner. In this case, an image with higher quality and a wider color gamut may be formed.

In addition, in the present exemplary embodiment, the average particle diameter of the fluorescent toner is less than the average particle diameter of the toner containing metal powder, less than the average particle diameter of the white toner, and less than the average particle diameter of the toner with adhesive performance.
More specifically, the average particle diameters of the toner containing metal powder, the white toner, and the toner with adhesive performance are 8 to 13 μm. In contrast, the average particle diameter of the fluorescent toner is 5 to 8 μm.
The average particle diameter of toner is a volume average particle diameter. The volume average particle diameter of toner may, for example, be measured by using a laser diffraction particle size distribution analyzer. When toner particles are elliptical, the average particle diameter of toner is the average major axis of the toner particles.

### Toner Lightness

The lightness of the fluorescent pink toner is lower than the lightness of the fluorescent green toner.
When solid images are compared in terms of lightness, the lightness of a solid image formed by using the fluorescent pink toner is lower than the lightness of a solid image formed by using the fluorescent green toner.
In other words, when images with a dot percent of 100% are compared, the lightness of an image formed by using the fluorescent pink toner is lower than the lightness of an image formed by using the fluorescent green toner.

Therefore, in the present exemplary embodiment, the fluorescent pink toner is used in the upstream additional-color image forming section 202A, and the fluorescent green toner is used in the downstream additional-color image forming section 202B.
In the present exemplary embodiment, the lightness of the fluorescent toner used in the upstream additional-color image forming section 202A is lower than the lightness of the fluorescent toner used in the downstream additional-color image forming section 202B.
In this case, an image with a wider color gamut may be formed on the paper sheet P compared to when the lightness of the fluorescent toner used in the upstream additional-color image forming section 202A is higher than the lightness of the fluorescent toner used in the downstream additional-color image forming section 202B.

When the lightness of the toner used in the upstream additional-color image forming section 202A is lower than the lightness of the toner used in the downstream additional-color image forming section 202B, the toner with the lower lightness is easily located in the surface-layer-side section of the image formed on the paper sheet P.
In the present exemplary embodiment, the fluorescent pink toner, which is the toner with the lower lightness, is easily located in the surface-layer-side section.
In this case, an image with a wider color gamut may be formed on the paper sheet P compared to when the fluorescent green toner, which is the toner with the higher lightness, is located in the surface-layer-side section.

Here, assume that the fluorescent pink toner, which is the toner with the lower lightness, is used in the downstream additional-color image forming section 202B.
In this case, the toner image formed by using the fluorescent pink toner is located in the paper-sheet-side section. In this case, the amount of light incident on the toner image with the lower lightness is reduced, and the color forming performance of the toner image with the lower lightness is reduced accordingly. In this case, an image with a wider color gamut cannot be easily formed.
In contrast, in the present exemplary embodiment, the toner image formed by using the fluorescent pink toner, which is the toner with the lower lightness, is located in the surface-layer-side section.
In this case, the amount of light incident on the toner image is increased, and the color forming performance of the toner image with the lower lightness is increased accordingly. In this case, an image with a wider color gamut can be easily formed.

In addition, in the present exemplary embodiment, the upstream additional-color image forming section 202A that uses the fluorescent pink toner is located upstream of the basic-color image forming sections 201 in the movement direction of the intermediate transfer belt 15. Therefore, in this case, the toner image formed by using the fluorescent pink toner is located in the surface-layer-side section that is on the surface-layer side of the basic-color toner images.
In this case, the color forming performance of the toner image formed by using the fluorescent pink toner is increased compared to when the toner image formed by using the fluorescent pink toner is located in the paper-sheet-side section that is closer to the paper sheet P than the basic-color toner images.

### Color Conversion of Image Data

The image forming apparatus 100 receives image data based on a color space, such as RGB, CMYK, or L*a*b*, output from, for example, an image reading device or a personal computer (PC) (not illustrated).
The image forming apparatus 100 acquires, for example, RGB image data based on which the above-described toner images to be transferred to the intermediate transfer belt 15 are formed.
The image forming apparatus 100 processes the image data. When the image data is processed, color conversion is performed by using preset parameters. As a result of the color conversion, image forming data, which is image data corresponding to each of the image forming sections 200, is created. In this case, the image forming data is created for each color.
More specifically, for example, the image forming data is created for each of the four colors, which are yellow, magenta, cyan, and black, and is also created for each of the additional colors, which are colors other than the four colors.
Then, the created image forming data is used to control the light emitted from the exposure device 13 provided in each of the image forming sections 200.

To create the image forming data for each color, the CPU 11a illustrated in FIG. 2, which is an example of a processor, acquires state information that is information regarding the states of the upstream additional-color image forming section 202A and the downstream additional-color image forming section 202B.
The creation of image forming data for each of the upstream additional-color image forming section 202A and the downstream additional-color image forming section 202B will now be described.
To create the image forming data, the CPU 11a acquires the state information, which is the information regarding the states of the upstream additional-color image forming section 202A and the downstream additional-color image forming section 202B.

More specifically, the CPU 11a acquires information regarding the types of the attached image forming units 250 as the state information.
Each image forming unit 250 is provided with a memory that stores information regarding the type of the image forming unit 250. The CPU 11a acquires the information regarding the type of the image forming unit 250 by receiving the information read from the memory.

The CPU 11a sets parameters used to create the image forming data based on the acquired state information. More specifically, the CPU 11a sets parameters to be used in the above-described color conversion.
More specifically, the CPU 11a reads and acquires parameters associated with the state determined by the acquired state information from the secondary storage 91 illustrated in FIG. 2.
In the present exemplary embodiment, the secondary storage 91 stores parameters registered for each image forming unit 250. The CPU 11a reads and acquires parameters associated with the state determined by the acquired state information from the secondary storage 91.

Then, the CPU 11a sets the parameters that have been read and acquired as the parameters to be used in the above-described color conversion.
Then, based on the parameters that have been set and the above-described RGB image data that has been acquired, the CPU 11a creates the image forming data, which is data used when the upstream additional-color image forming section 202A and the downstream additional-color image forming section 202B form toner images.

When the CPU 11a sets the parameters, the CPU 11a may determine whether or not set parameters, which are parameters set at that time, are parameters that match the current state.
In this case, if the set parameters are the parameters that match the current state, it is not necessary to set new parameters.
The new parameters may be set if the set parameters are not the parameters that match the current state.

In this case, if the set parameters do not match the state determined based on the state information, the CPU 11a sets the new parameters to be used to create the image forming data.
Alternatively, if the set parameters do not match the state determined based on the state information, the CPU 11a may present a predetermined notification to the user.

The notification is presented through, for example, the UI 45.
Accordingly, the user of the image forming apparatus 100 realizes that the parameters set at that time are parameters that do not match the current state.
In this case, the user inputs an instruction to set the new parameters through the UI 45.
Accordingly, as described above, the CPU 11a reads and acquires parameters associated with the state determined by the acquired state information from the secondary storage 91. Then, the CPU sets the acquired parameters as the new parameters.

### Another Example of Intermediate-Transfer Image Forming Apparatus

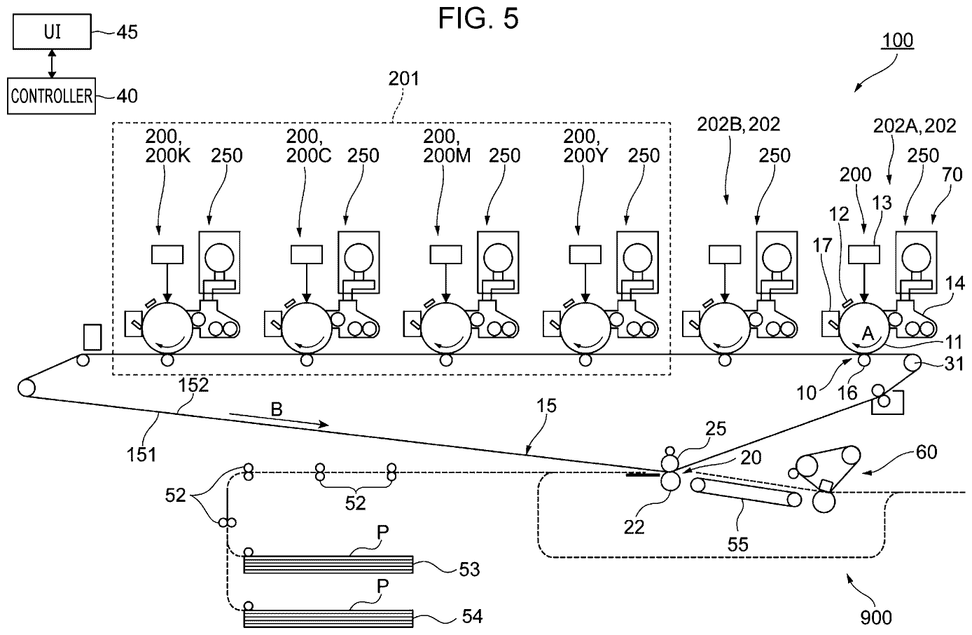

FIG. 5 illustrates another example of an image forming apparatus 100.

In this example, similarly to the above-described example, the upstream additional-color image forming section 202A is provided upstream of the basic-color image forming sections 201 in the movement direction of the intermediate transfer belt 15.

In this example, the downstream additional-color image forming section 202B is also provided upstream of the basic-color image forming sections 201 in the movement direction of the intermediate transfer belt 15.

The arrangement of the upstream additional-color image forming section 202A, the downstream additional-color image forming section 202B, and the basic-color image forming sections 201 is not limited to the arrangement illustrated in FIG. 1.
The upstream additional-color image forming section 202A and the downstream additional-color image forming section 202B may be provided upstream of the basic-color image forming sections 201.

Also in this example, similarly to the above-described example, the lightness of toner used in the upstream additional-color image forming section 202A is lower than the lightness of toner used in the downstream additional-color image forming section 202B.
More specifically, also in this example, the toner used in the upstream additional-color image forming section 202A is fluorescent pink toner. In addition, the toner used in the downstream additional-color image forming section 202B is fluorescent green toner.
Also in this example, an image with a wider color gamut may be formed compared to when the image forming section 200 that uses the fluorescent pink toner is located downstream of the image forming section 200 that uses the fluorescent green toner.
Also in the example illustrated in FIG. 5, similarly to the above-described example, the image forming unit 250 of each image forming section 200 is replaceable.

### Direct-Transfer Image Forming Apparatus

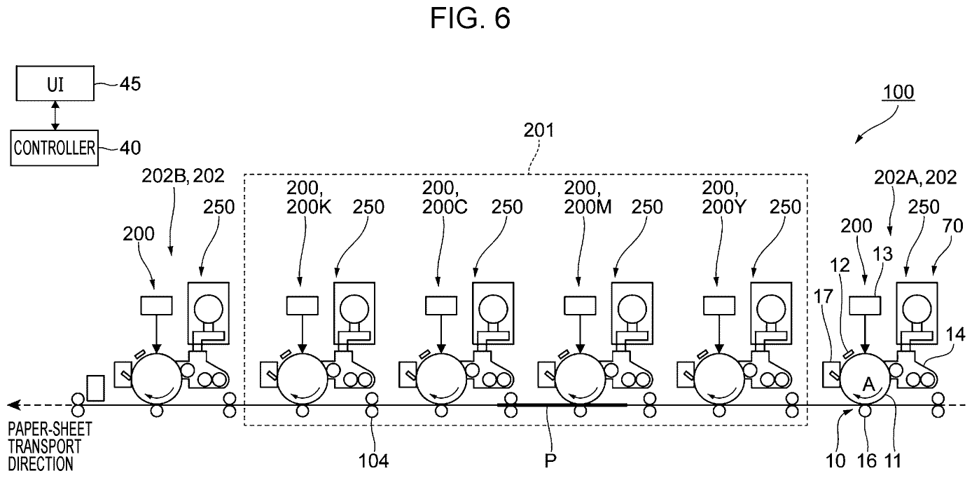

FIG. 6 illustrates a direct-transfer image forming apparatus 100.
In this example, images formed by the upstream additional-color image forming section 202A, the downstream additional-color image forming section 202B, and the basic-color image forming sections 201 are directly transferred to the paper sheet P, which is an example of a transfer medium.
The paper sheet P is transported by transport rollers 104 that rotate. The transport rollers 104 are examples of transport units.
Also in this example, the upstream additional-color image forming section 202A and the downstream additional-color image forming section 202B are provided. In this example, the upstream additional-color image forming section 202A is provided upstream of the basic-color image forming sections 201. The downstream additional-color image forming section 202B is provided downstream of the basic-color image forming sections 201.

In this example, toner used in the downstream additional-color image forming section 202B is fluorescent pink toner. In addition, toner used in the upstream additional-color image forming section 202A is fluorescent green toner.
In the image forming apparatus 100 illustrated in FIG. 6, similarly to the above-described example, the fluorescent pink toner is easily located in the surface-layer-side section of the image formed on the paper sheet P.
Also in the example illustrated in FIG. 6, similarly to the above-described example, the image forming unit 250 of each image forming section 200 is replaceable.

### Another Example of Direct-Transfer Image Forming Apparatus

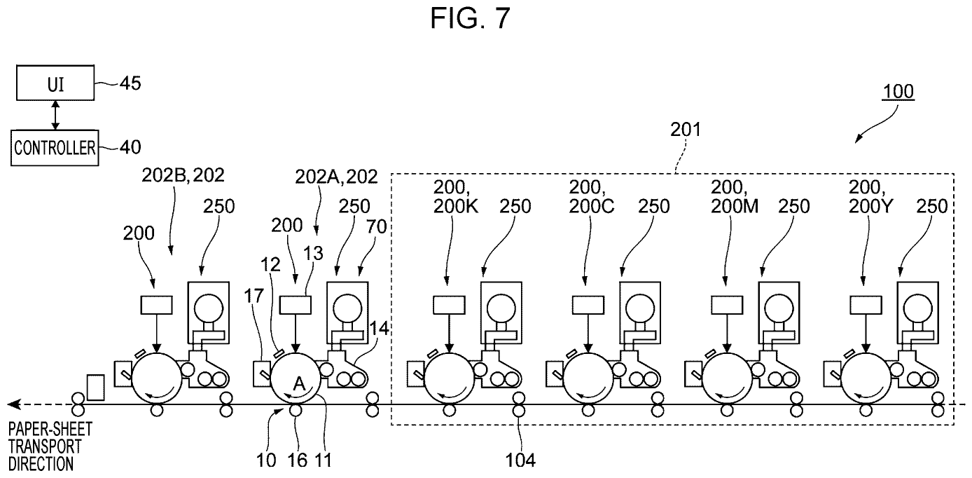

FIG. 7 illustrates another example of a direct-transfer image forming apparatus 100.
The apparatus may include a direct-transfer system and have the structure illustrated in FIG. 7.
The image forming apparatus 100 illustrated in FIG. 7 includes a direct-transfer system, and the upstream additional-color image forming section 202A and the downstream additional-color image forming section 202B are located downstream of the basic-color image forming sections 201.
Also in this example, toner used in the downstream additional-color image forming section 202B is fluorescent pink toner. In addition, toner used in the upstream additional-color image forming section 202A is fluorescent green toner.

Also in the image forming apparatus 100 illustrated in FIG. 7, similarly to the above-described example, the image formed of the fluorescent pink toner is easily located in the surface-layer-side section of the image formed on the paper sheet P.
Also in the image forming apparatus 100 illustrated in FIG. 7, the toner image formed of the fluorescent pink toner is easily located on the surface-layer side of the toner image formed of the fluorescent green toner.
Also in the example illustrated in FIG. 7, similarly to the above-described example, the image forming unit 250 of each image forming section 200 is replaceable.

In the example illustrated in FIG. 7, the upstream additional-color image forming section 202A and the downstream additional-color image forming section 202B are provided downstream of the basic-color image forming sections 201.
The arrangement is not limited to this, and the upstream additional-color image forming section 202A and the downstream additional-color image forming section 202B may be provided upstream of the basic-color image forming sections 201.
Also in this case, the toner used in the downstream additional-color image forming section 202B may be the fluorescent pink toner, and the toner used in the upstream additional-color image forming section 202A may be the fluorescent green toner.

### Use of OGV Toner

Although the fluorescent toner is used as the toners of additional colors in the above-described example, examples of the toners of additional colors also include OGV toners. The OGV toners may be used as the toners of additional colors.
As described above, the OGV toners are orange, green, and violet toners. The OGV toners are non-fluorescent toner.

The additional-color image forming sections 202 that use the fluorescent pink toner and the fluorescent green toner may be replaced by additional-color image forming sections 202 that use the OGV toners.
In other words, an additional-color image forming section 202 that uses non-fluorescent orange toner, an additional-color image forming section 202 that uses non-fluorescent green toner, and an additional-color image forming section 202 that uses non-fluorescent violet toner may be provided.
In this case, three image forming sections 200 are provided in addition to the four image forming sections 200 that are the basic-color image forming sections 201, and a total of seven image forming sections 200 are provided.
Although the OGV toners are also used in the above-described Hi-Fi color printing, the additional-color image forming sections 202 are arranged in a specific manner in this example.

When the three additional-color image forming sections 202 that correspond to orange, green, and violet are provided, the three image forming sections 200 may be arranged in order of the lightness of the toner.
More specifically, in the intermediate transfer systems illustrated in FIGS. 1 and 5, the additional-color image forming sections 202 corresponding to violet, green, and orange may be arranged in that order from the upstream side toward the downstream side in the movement direction of the intermediate transfer belt 15.

In the direct-transfer systems illustrated in FIGS. 6 and 7, the additional-color image forming sections 202 corresponding to orange, green, and violet may be arranged in the order of from the upstream side toward the downstream side in the transport direction of the paper sheet P.
The three additional-color image forming sections 202 corresponding to green, orange, and violet may all be disposed on one of the upstream side and the downstream side of the basic-color image forming sections 201.
Alternatively, one or more of the three additional-color image forming sections 202 may be provided on one of the upstream side and the downstream side of the basic-color image forming sections 201, and the remaining one or more of the three additional-color image forming sections 202 may be provided on the other side.

The locations of the additional-color image forming sections 202 corresponding to violet, orange, and green may be regarded as non-fluorescent image forming sections, which are image forming sections 200 that form images using toners of non-fluorescent colors.
The non-fluorescent image forming sections use violet, orange, and green toners. The non-fluorescent image forming sections use toners of colors other than yellow, magenta, cyan, and black.
In the present exemplary embodiment, plural image forming sections 200 are provided as the non-fluorescent image forming sections.
The non-fluorescent image forming sections include the image forming section 200 that uses the non-fluorescent orange toner, the image forming section 200 that uses the non-fluorescent green toner, and the image forming section 200 that uses the non-fluorescent violet toner.

The image forming apparatus 100 may include the non-fluorescent image forming sections, the image forming section 200 corresponding to fluorescent pink, and the image forming section 200 corresponding to fluorescent green in addition to the basic-color image forming sections 201.
In this case, the image forming apparatus 100 includes the basic-color image forming sections 201, the non-fluorescent image forming sections, and the fluorescent image forming sections 200.
More specifically, in this case, nine image forming sections 200 are provided.
According to this structure, the color gamut may be expanded in dark and high saturation regions in addition to regions that are expanded when only the image forming section 200 corresponding to fluorescent pink and the image forming section 200 corresponding to fluorescent green are used.

Also in this case, the image forming sections 200 may be arranged in order of the lightness of the toner.
More specifically, as described above, the three image forming sections 200 corresponding to violet, orange, and green may be arranged in the order of violet, green, and orange, or in the order or orange, green, and violet.
More specifically, in the intermediate transfer systems, the three image forming sections 200 corresponding to violet, green, and orange may be arranged in that order from the upstream side toward the downstream side in the movement direction of the intermediate transfer belt 15.
In the direct-transfer systems, the three image forming sections 200 corresponding to orange, green, and violet may be arranged in that order from the upstream side toward the downstream side in the transport direction of the paper sheet P.

In addition, among the nine image forming sections 200, the image forming sections 200 corresponding to fluorescent pink and fluorescent green may be arranged in the order of fluorescent pink and fluorescent green.
More specifically, in the intermediate transfer systems, the image forming sections 200 may be arranged in the order of fluorescent pink and fluorescent green from the upstream side toward the downstream side in the movement direction of the intermediate transfer belt 15.
In the direct-transfer systems, the image forming section 200 may be arranged in the order of fluorescent green and fluorescent pink from the upstream side toward the downstream side in the transport direction of the paper sheet P.

An instruction unit may be additionally provided to issue an instruction to the user to cause the upstream additional-color image forming section 202A to use toner of an additional color with low lightness.
The instruction unit is formed of, for example, the CPU 11a and the UI 45.
In the intermediate-transfer image forming apparatuses 100, the CPU 11a issues an instruction to the user to cause the upstream additional-color image forming section 202A to use toner of an additional color with low lightness.
In the present exemplary embodiment, as described above, the image forming units 250 may be attached to the upstream additional-color image forming section 202A and the downstream additional-color image forming section 202B after each image forming apparatus 100 is shipped.

In this case, the above-described instruction increases the possibility that toner of an additional color with low lightness will be used in the upstream additional-color image forming section 202A.
More specifically, for example, the CPU 11a may cause the UI 45 to display the instruction: “When using fluorescent pink toner, attach the pink cartridge to the upstream additional-color image forming section 202A.”
In this case, the user receives an instruction to cause the upstream additional-color image forming section 202A to use toner of an additional color with low lightness.

Alternatively, for example, the CPU 11a may cause the UI 45 to display the instruction: “When using fluorescent pink toner and fluorescent green toner, attach the pink cartridge to the upstream additional-color image forming section 202A and the green cartridge to the downstream additional-color image forming section 202B.”
Also in this case, user receives an instruction to cause the upstream additional-color image forming section 202A to use toner of an additional color with low lightness.
Also when the above-described OGV toners are used, the user may similarly receive an instruction to cause the upstream additional-color image forming section 202A to use toner of an additional color with low lightness.

In addition, in the direct-transfer image forming apparatuses 100, the CPU 11a issues an instruction to the user to cause the downstream additional-color image forming section 202B to use toner of an additional color with low lightness.
This increases the possibility that toner of an additional color with low lightness will be used in the downstream additional-color image forming section 202B.
In the direct transfer system, for example, the CPU 11a may cause the UI 45 to display the instruction: “When using fluorescent pink toner, attach the pink cartridge to the downstream additional-color image forming section 202B.”

Alternatively, for example, the CPU 11a may cause the UI 45 to display the instruction: “When using fluorescent pink toner and fluorescent green toner, attach the pink cartridge to the downstream additional-color image forming section 202B and the green cartridge to the upstream additional-color image forming section 202A.”
In this case, user receives an instruction to cause the downstream additional-color image forming section 202B to use toner of an additional color with low lightness.
Similarly to the above-described case, also when the above-described OGV toners are used, the user may receive an instruction to cause the downstream additional-color image forming section 202B to use toner of an additional color with low lightness.

### Charging of Toner

Charging of toner will now be described.
In the intermediate-transfer image forming apparatuses 100 illustrated in FIG. 1 and FIG. 5, the charge amount of the toner used in the downstream additional-color image forming section 202B may be greater than the charge amount of the toner used in the upstream additional-color image forming section 202A.
In the above-described example, the toner used in the downstream additional-color image forming section 202B is fluorescent green toner, and the toner used in the upstream additional-color image forming section 202A is fluorescent pink toner.
In this case, the charge amount of the fluorescent green toner may be greater than the charge amount of the fluorescent pink toner.

For example, carriers of different performances may be used so that the charge amount of the toner used in the downstream additional-color image forming section 202B is greater than the charge amount of the toner used in the upstream additional-color image forming section 202A.
More specifically, the carrier used in the upstream additional-color image forming section 202A and the carrier used in the downstream additional-color image forming section 202B may have different performances.

In each of the upstream additional-color image forming section 202A and the downstream additional-color image forming section 202B, toner is charged by agitating the toner with carrier.
In this case, carriers of different performances are used in the upstream additional-color image forming section 202A and the downstream additional-color image forming section 202B. Accordingly, the toners may be charged such that the charge amount of the toner used in the downstream additional-color image forming section 202B is greater than the charge amount of the toner used in the upstream additional-color image forming section 202A.

Although not described above, there is no particular limitation regarding the carrier used in the image forming sections 200, and commonly known carrier may be used.
Examples of the carrier include coated carrier prepared by coating the surfaces of cores formed of magnetic powder with a resin, magnetic-powder-dispersed carrier prepared by dispersing magnetic powder in a matrix resin, or resin-impregnated carrier prepared by impregnating porous magnetic powder with a resin.
The magnetic-powder-dispersed carrier and the resin-impregnated carrier may be carrier prepared by coating the surfaces of cores formed of constituent particles of the carrier with a resin.

When the charge amount of the toner used in the downstream additional-color image forming section 202B is to be greater than the charge amount of the toner used in the upstream additional-color image forming section 202A, carriers of different performances are used, as described above.
More specifically, in this case, for example, the electrical resistance of the carrier used in the downstream additional-color image forming section 202B is greater than the electrical resistance of the carrier used in the upstream additional-color image forming section 202A.
More specifically, the types and amounts of coating materials for coating the carrier are adjusted such that the electrical resistance of the carrier used in the downstream additional-color image forming section 202B is greater than the electrical resistance of the carrier used in the upstream additional-color image forming section 202A.

Here, each image forming section 200 may cause a phenomenon referred to as toner fogging resulting from, for example, the toner having a small charge amount when a toner image is formed. In this case, the toner adheres to a non-image region in which no image is to be formed.
Even when toner fogging occurs, the influence of the toner fogging on the image formed on the paper sheet P is small if the image forming section 200 in which the toner fogging has occurred is at an upstream location in the movement direction of the intermediate transfer belt 15.

If the image forming section 200 in which the toner fogging has occurred is at an upstream location, the toner adhering to the non-image region moves to the photoconductor drum 11 included in another image forming section 200, which is located downstream of the image forming section 200 in which the toner fogging has occurred, when the toner reaches the other image forming section 200.
In this specification, this movement of the toner to the photoconductor drum 11 will be referred to as “reverse movement”.
In the present exemplary embodiment, the reverse movement reduces the toner adhering to the non-image region.
In contrast, assume that the image forming section 200 in which the toner fogging has occurred is at a downstream location in the movement direction of the intermediate transfer belt 15. In this case, the opportunity of reverse movement is reduced, and the toner adhering to the non-image region is not be easily reduced.
In this case, the quality of the image formed on the paper sheet P is easily degraded.

In light of the above-described circumstances, according to the present exemplary embodiment, as described above, the charge amount of the toner used in the downstream additional-color image forming section 202B is greater than the charge amount of the toner used in the upstream additional-color image forming section 202A.
In this case, the occurrence of toner fogging can be reduced in the downstream additional-color image forming section 202B.

Although the charge amount of the toner may also be increased in the upstream additional-color image forming section 202A, in such a case, there is a possibility that the toner image cannot be easily transferred from the intermediate transfer belt 15 to the paper sheet P.
When the charge amount of the toner used in the upstream additional-color image forming section 202A is also increased, the total charge amount of the toner images formed on the intermediate transfer belt 15 is increased. In such a case, the total charge amount of the toner images immediately before transfer to the paper sheet P is increased.
In this case, there is a possibility that the toner images cannot be easily transferred from the intermediate transfer belt 15 to the paper sheet P.

In contrast, in the present exemplary embodiment, the charge amount of the toner used in the downstream additional-color image forming section 202B is greater than the charge amount of the toner used in the upstream additional-color image forming section 202A.
In this case, the total charge amount of the toner images formed on the intermediate transfer belt 15 is reduced compared to when the charge amount of the toner used in the upstream additional-color image forming section 202A is also increased.
In this case, the degradation of the image quality due to toner fogging is less likely to occur, and the toner images are more easily transferred from the intermediate transfer belt 15 to the paper sheet P.

The direct-transfer image forming apparatuses 100 illustrated in FIGS. 6 and 7 may have a similar configuration. In other words, the charge amount of the toner used in the downstream additional-color image forming section 202B may be greater than the charge amount of the toner used in the upstream additional-color image forming section 202A.
In addition, as described above, the non-fluorescent image forming sections in which OGV toners are used may be provided instead of or in addition to the fluorescent additional-color image forming sections 202.
The above-described three image forming sections 200 that serve as the non-fluorescent image forming sections may also be arranged such that the charge amount of the toners used in the image forming sections 200 increases toward the downstream side.

An instruction unit may be additionally provided to issue an instruction to the user to cause the downstream additional-color image forming section 202B to use toner with a large charge amount.
The instruction unit is formed of, for example, the CPU 11a and the UI 45.
The user may be receive an instruction to cause the downstream additional-color image forming section 202B to use toner of an additional color with a large charge amount in both the intermediate transfer system and the direct transfer system.

In the present exemplary embodiment, as described above, the image forming units 250 may be attached to the upstream additional-color image forming section 202A and the downstream additional-color image forming section 202B after each image forming apparatus 100 is shipped.
In this case, when user receives an instruction to cause the downstream additional-color image forming section 202B to use toner of an additional color with a large charge amount, the possibility that the toner of an additional color with a large charge amount will be used in the downstream additional-color image forming section 202B increases.

More specifically, for example, the CPU 11a may cause the UI 45 to display the instruction: “When using fluorescent pink toner and fluorescent green toner, attach the pink cartridge to the upstream additional-color image forming section 202A and the green cartridge to the downstream additional-color image forming section 202B.”
In this case, the user substantially receives an instruction to cause the downstream additional-color image forming section 202B to use toner of an additional color with a large charge amount.

Alternatively, an instruction unit may be additionally provided to issue an instruction to the user to cause the upstream additional-color image forming section 202A to use toner with a small charge amount.
Also in this case, the instruction unit is formed of, for example, the CPU 11a and the UI 45.
In this case, for example, the CPU 11a may cause the UI 45 to display the instruction: “When using fluorescent pink toner, attach the cartridge to the upstream additional-color image forming section 202A”.
In this case, the user substantially receives an instruction to cause the upstream additional-color image forming section 202A to use toner of an additional color with a small charge amount.
In this case, the possibility that the toner of an additional color with a small charge amount will be used in the downstream additional-color image forming section 202B is reduced.

Although the above-described image forming apparatuses 100 use toner, the image forming apparatuses 100 are not limited to image forming apparatuses 100 that use toner.
The image forming apparatuses 100 may be inkjet image forming apparatuses 100 or offset printing image forming apparatuses 100.
The above-described configurations may also be applied to inkjet image forming apparatuses 100 and offset printing image forming apparatuses 100.
In addition, the above-described arrangements regarding toner may be applied to ink for inkjet printing and ink for offset printing.
In this case, the non-fluorescent coloring materials and the fluorescent coloring materials used in the image forming apparatus 100 are formed of ink for inkjet printing or ink for offset printing.
The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

### 1

An image forming apparatus including:
a mover that moves a transfer medium;
a basic-color image forming section that is an image forming section that forms an image by using toner of one or more colors selected from four colors including yellow, magenta, cyan, and black, the image being transferred to the transfer medium; and
plural additional-color image forming sections, each of which forms an image by using toner of an additional color other than the four colors, the image being transferred to the transfer medium,
wherein the plural additional-color image forming sections include an upstream additional-color image forming section and a downstream additional-color image forming section located downstream of the upstream additional-color image forming section in a movement direction in which the transfer medium is moved, and
wherein the toner of the additional color used in the downstream additional-color image forming section has a charge amount greater than a charge amount of the toner of the additional color used in the upstream additional-color image forming section.

### 2

The image forming apparatus according to (((1))),
wherein the upstream additional-color image forming section is provided upstream of the basic-color image forming section in the movement direction of the transfer medium.

### 3

The image forming apparatus according to (((2))),
wherein the downstream additional-color image forming section is provided upstream of the basic-color image forming section in the movement direction of the transfer medium.

### 4

The image forming apparatus according to (((1))),
wherein the upstream additional-color image forming section is provided upstream of the basic-color image forming section in the movement direction of the transfer medium,
wherein the downstream additional-color image forming section is provided downstream of the basic-color image forming section in the movement direction of the transfer medium, and
wherein the toner of the additional color used in the downstream additional-color image forming section located downstream of the basic-color image forming section has the charge amount greater than the charge amount of the toner of the additional color used in the upstream additional-color image forming section located upstream of the basic-color image forming section.

### 5

The image forming apparatus according to (((4))),
wherein at least one of the upstream additional-color image forming section and the downstream additional-color image forming section includes a unit that is used to form an image and that is replaceable, and is capable of forming an image with a function different from a function of an image formed before the unit is replaced.

### 6

The Image Forming Apparatus According to (((5))),
wherein the one of the upstream additional-color image forming section and the downstream additional-color image forming section is capable of forming an image that is highly reflective of light or an image with adhesive performance when the unit is replaced.

### 7

The image forming apparatus according to (((4))),
wherein at least one of the upstream additional-color image forming section and the downstream additional-color image forming section includes a unit that is used to form an image and that is replaceable, and is capable of forming an image of a color different from a color of an image formed before the unit is replaced.

### 8

The image forming apparatus according to (((7))),
wherein the one of the upstream additional-color image forming section and the downstream additional-color image forming section is capable of forming an image with metallic luster, a white image, or a transparent image when the unit is replaced.

### 9

The image forming apparatus according to (((4))),
wherein the basic-color image forming section includes plural image forming units arranged in the movement direction of the transfer medium, and
wherein the downstream additional-color image forming section is provided downstream of the basic-color image forming section to allow an image to be formed by using toner of a color other than the four colors at a location downstream of the basic-color image forming section without removing an image forming unit that is one of the plural image forming units included in the basic-color image forming section and that is located most downstream among the plural image forming units.

### 10

The image forming apparatus according to any one of (((1))) to (((9))),
wherein, in each of the upstream additional-color image forming section and the downstream additional-color image forming section, the toner of the additional color is agitated with carrier to charge the toner of the additional color, and
wherein the carrier provided in the upstream additional-color image forming section and the carrier provided in the downstream additional-color image forming section have different performances so that the toner of the additional color used in the downstream additional-color image forming section has the charge amount greater than the charge amount of the toner of the additional color used in the upstream additional-color image forming section.

### 11

The image forming apparatus according to any one of (((1))) to (((10))),
wherein the upstream additional-color image forming section forms an image by using fluorescent pink toner, and
wherein the downstream additional-color image forming section forms an image by using fluorescent green toner having a charge amount greater than a charge amount of the fluorescent pink toner.

### 12

An image forming apparatus comprising:
a mover that moves a transfer medium;
a basic-color image forming section that is an image forming section that forms an image by using toner of one or more colors selected from four colors including yellow, magenta, cyan, and black, the image being transferred to the transfer medium; and
plural additional-color image forming sections, each of which is capable of forming an image by using toner of an additional color other than the four colors, the image being transferred to the transfer medium,
wherein the plural additional-color image forming sections include an upstream additional-color image forming section and a downstream additional-color image forming section located downstream of the upstream additional-color image forming section in a movement direction in which the transfer medium is moved, and
wherein the downstream additional-color image forming section is capable of using the toner of the additional color having a charge amount greater than a charge amount of the toner of the additional color used in the upstream additional-color image forming section located upstream of the downstream additional-color image forming section.

### 13

The image forming apparatus according to (((12))),
wherein the upstream additional-color image forming section is provided upstream of the basic-color image forming section in the movement direction of the transfer medium,
wherein the downstream additional-color image forming section is provided downstream of the basic-color image forming section in the movement direction of the transfer medium, and
wherein the downstream additional-color image forming section located downstream of the basic-color image forming section is capable of using the toner of the additional color having the charge amount greater than the charge amount of the toner of the additional color used in the upstream additional-color image forming section.

### 14

The image forming apparatus according to (((12))) or (((13))),
wherein the upstream additional-color image forming section is capable of using fluorescent pink toner, and
wherein the downstream additional-color image forming section is capable of using fluorescent green toner having a charge amount greater than a charge amount of the fluorescent pink toner.

### 15

The image forming apparatus according to any one of (((12))) to (((14))), further including:
an instruction unit that provides an instruction to a user to cause the downstream additional-color image forming section to use the toner of the additional color having a large charge amount.

What is claimed is:

1. An image forming apparatus comprising:
a mover that moves a transfer medium;
a basic-color image forming section that is an image forming section that forms an image by using toner of one or more colors selected from four colors including yellow, magenta, cyan, and black, the image being transferred to the transfer medium; and
a plurality of additional-color image forming sections, each of which forms an image by using toner of an additional color other than the four colors, the image being transferred to the transfer medium,
wherein the plurality of additional-color image forming sections include an upstream additional-color image forming section and a downstream additional-color image forming section located downstream of the upstream additional-color image forming section in a movement direction in which the transfer medium is moved, and
wherein the toner of the additional color used in the downstream additional-color image forming section has a charge amount greater than a charge amount of the toner of the additional color used in the upstream additional-color image forming section.

2. The image forming apparatus according to claim 1,
wherein the upstream additional-color image forming section is provided upstream of the basic-color image forming section in the movement direction of the transfer medium.

3. The image forming apparatus according to claim 2,
wherein the downstream additional-color image forming section is provided upstream of the basic-color image forming section in the movement direction of the transfer medium.

4. The image forming apparatus according to claim 1,
wherein the upstream additional-color image forming section is provided upstream of the basic-color image forming section in the movement direction of the transfer medium,
wherein the downstream additional-color image forming section is provided downstream of the basic-color image forming section in the movement direction of the transfer medium, and
wherein the toner of the additional color used in the downstream additional-color image forming section located downstream of the basic-color image forming section has the charge amount greater than the charge amount of the toner of the additional color used in the upstream additional-color image forming section located upstream of the basic-color image forming section.

5. The image forming apparatus according to claim 4,
wherein at least one of the upstream additional-color image forming section and the downstream additional-color image forming section includes a unit that is used to form an image and that is replaceable, and is capable of forming an image with a function different from a function of an image formed before the unit is replaced.

6. The image forming apparatus according to claim 5,
wherein the one of the upstream additional-color image forming section and the downstream additional-color image forming section is capable of forming an image that is highly reflective of light or an image with adhesive performance when the unit is replaced.

7. The image forming apparatus according to claim 4,
wherein at least one of the upstream additional-color image forming section and the downstream additional-color image forming section includes a unit that is used to form an image and that is replaceable, and is capable of forming an image of a color different from a color of an image formed before the unit is replaced.

8. The image forming apparatus according to claim 7,
wherein the one of the upstream additional-color image forming section and the downstream additional-color image forming section is capable of forming an image with metallic luster, a white image, or a transparent image when the unit is replaced.

9. The image forming apparatus according to claim 4,
wherein the basic-color image forming section includes a plurality of image forming units arranged in the movement direction of the transfer medium, and
wherein the downstream additional-color image forming section is provided downstream of the basic-color image forming section to allow an image to be formed by using toner of a color other than the four colors at a location downstream of the basic-color image forming section without removing an image forming unit that is one of the plurality of image forming units included in the basic-color image forming section and that is located most downstream among the plurality of image forming units.

10. The image forming apparatus according to claim 1,
wherein, in each of the upstream additional-color image forming section and the downstream additional-color image forming section, the toner of the additional color is agitated with carrier to charge the toner of the additional color, and
wherein the carrier provided in the upstream additional-color image forming section and the carrier provided in the downstream additional-color image forming section have different performances so that the toner of the additional color used in the downstream additional-color image forming section has the charge amount greater than the charge amount of the toner of the additional color used in the upstream additional-color image forming section.

11. The image forming apparatus according to claim 1,
wherein the upstream additional-color image forming section forms an image by using fluorescent pink toner, and
wherein the downstream additional-color image forming section forms an image by using fluorescent green toner having a charge amount greater than a charge amount of the fluorescent pink toner.

12. An image forming apparatus comprising:
a mover that moves a transfer medium;
a basic-color image forming section that is an image forming section that forms an image by using toner of one or more colors selected from four colors including yellow, magenta, cyan, and black, the image being transferred to the transfer medium; and
a plurality of additional-color image forming sections, each of which is capable of forming an image by using toner of an additional color other than the four colors, the image being transferred to the transfer medium,
wherein the plurality of additional-color image forming sections include an upstream additional-color image forming section and a downstream additional-color image forming section located downstream of the upstream additional-color image forming section in a movement direction in which the transfer medium is moved, and
wherein the downstream additional-color image forming section is capable of using the toner of the additional color having a charge amount greater than a charge amount of the toner of the additional color used in the upstream additional-color image forming section located upstream of the downstream additional-color image forming section.

13. The image forming apparatus according to claim 12,
wherein the upstream additional-color image forming section is provided upstream of the basic-color image forming section in the movement direction of the transfer medium,
wherein the downstream additional-color image forming section is provided downstream of the basic-color image forming section in the movement direction of the transfer medium, and
wherein the downstream additional-color image forming section located downstream of the basic-color image forming section is capable of using the toner of the additional color having the charge amount greater than the charge amount of the toner of the additional color used in the upstream additional-color image forming section.

14. The image forming apparatus according to claim 12,
wherein the upstream additional-color image forming section is capable of using fluorescent pink toner, and
wherein the downstream additional-color image forming section is capable of using fluorescent green toner having a charge amount greater than a charge amount of the fluorescent pink toner.

15. The image forming apparatus according to claim 12, further comprising:
an instruction unit that provides an instruction to a user to cause the downstream additional-color image forming section to use the toner of the additional color having a large charge amount.

16. An image forming apparatus comprising:
moving means for moving a transfer medium;
a basic-color image forming section that is an image forming section that forms an image by using toner of one or more colors selected from four colors including yellow, magenta, cyan, and black, the image being transferred to the transfer medium; and
a plurality of additional-color image forming sections, each of which forms an image by using toner of an additional color other than the four colors, the image being transferred to the transfer medium,
wherein the plurality of additional-color image forming sections include an upstream additional-color image forming section and a downstream additional-color image forming section located downstream of the upstream additional-color image forming section in a movement direction in which the transfer medium is moved, and
wherein the toner of the additional color used in the downstream additional-color image forming section has a charge amount greater than a charge amount of the toner of the additional color used in the upstream additional-color image forming section.
